(19) United States
(12) Patent Application Publication
(10) Pub. No.: US 2026/0268810 A1
(43) Pub. Date: Sep. 10, 2026

(54) DISPLAY CASE

(71) Applicant: CHUNG-HAO HSU, Taipei City (TW)

(72) Inventor: CHUNG-HAO HSU, Taipei City (TW)

(21) Appl. No.: 19/558,429

(22) Filed: Mar. 5, 2026

(30) Foreign Application Priority Data
Mar. 5, 2025 (TW) 114108133

(51) Int. Cl. G09F 9/30; A47F 3/00; A47F 3/14; G06F 3/01; G06F 40/20; G06F 40/40; G06V 10/70; G06V 40/10; G10L 15/22

(52) U.S. Cl. CPC G09F 9/30; A47F 3/001; A47F 3/145; G06F 3/011; G06F 40/20; G06F 40/40; G06V 10/70; G06V 40/10; G10L 15/22

(57) ABSTRACT

A display case is adapted to display a display object and includes a body, a display panel having a first side and a second side opposite to each other, an AI server, and a light source disposed in the body and controllable to be turned on or be turned off. The first side faces toward the receiving space. The second side faces away from the receiving space. A transmittance of the display panel from the first side to the second side is greater than a transmittance of the display panel from the second side to the first side. The AI server is disposed on the body, is electrically connected to the display panel, and includes a processing unit. The processing unit receives a signal, transforms the signal into a text, analyzes a meaning of the text, and correspondingly generates a reply. The display panel displays the reply.

### BACKGROUND OF THE INVENTION

### Technical Field

The present invention relates generally to a case, and more particularly to a display case.

### Description of Related Art

In recent years, it is known that a commercial advertisement has been an important part of selling a product. To arouse interests of consumers to buy the product, the product is displayed through a display case to appeal to the consumers to see the product, so that an attention to the product and a sales revenue of the product are raised. The product is commonly placed in the conventional display case and some decorations or some sceneries are used to decorate the display case, so that the product displayed through the display case could gain more attention of the consumers.

However, to avoid affect consumer experiences of the consumers, if a display object of the conventional display case would be replaced, the display object is replaced after the store is closed and the display object could not be temporarily replaced during a business hour of the store. When the decorations or the sceneries are replaced with the display object being replaced, multiple resources are wasted. In addition to providing a service of seeing the product to the consumers, how to raise a connection between the consumers and the product is a problem needed to be solved.

### BRIEF SUMMARY OF THE INVENTION

In view of the above, the primary objective of the present invention is to provide a display case, which could be decorated through a display panel disposed on the display case, allow a display object to be conveniently replaced, and raise a connection between consumers and a product.

The present invention provides a display case adapted to display a display object and including a body, a display panel, an AI server, and a light source, wherein the body has a receiving space and a side opening. The receiving space is adapted to accommodate the display object. The display panel is disposed on the body and covers the side opening. The display panel has a first side and a second side opposite to each other, wherein the first side faces toward the receiving space. The second side faces away from the receiving space. A transmittance of the display panel in a direction from the first side to the second side is greater than a transmittance of the display panel in a direction from the second side to the first side. The AI server is disposed on the body and is electrically connected to the display panel. The AI server includes a processing unit, wherein the processing unit is adapted to receive a signal and transform the signal into a text. The processing unit analyzes a meaning of the text and correspondingly generates a reply. The display panel displays the reply. The light source is disposed in the body and is controllable to be turned on or be turned off.

With the aforementioned design, when the light source is turned on, a light of the light source could penetrate through the first side to the second side, so that the display object located in the receiving space could be seen by the consumers outside the display case through the display panel. When the light source is turned off, an ambient light outside the display case could not penetrate through the second side to the first side, so that the display object located in the receiving space could not be seen outside the display case. Therefore, when the display object needs to be replaced, the display object could be replaced without the display object seen by the consumers through the light source being turned off, thereby allowing the display object to be conveniently replaced. In addition, through the display panel disposed on the display case, an effect of decorating the display case could be achieved, thereby reducing a waste of physical decorations. In addition, through the AI server, the consumers could input words related to the display object and the processing unit could transform the words inputted by the consumers into the text. The words inputted by the consumers could be “Please display the information related to the display object.” as an example. The display panel could display the reply corresponding to the words. The reply could be a related information including a price of the display object, a color choice of the display object, and a size range of the display object as an example. Therefore, the consumers could know further about the display object, thereby raising the connection between the consumers and the product.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the display case, showing a front side of the display case according to an embodiment of the present invention;

FIG. 2 is a sectional view along the A-A line in FIG. 1;

FIG. 3 is a perspective view of the display case according to the embodiment of the present invention;

FIG. 4 is a perspective view of the display case, showing a backside of the display case according to the embodiment of the present invention; and

FIG. 5 is a block diagram of the display case according to the embodiment of the present invention.

### DETAILED DESCRIPTION OF THE INVENTION

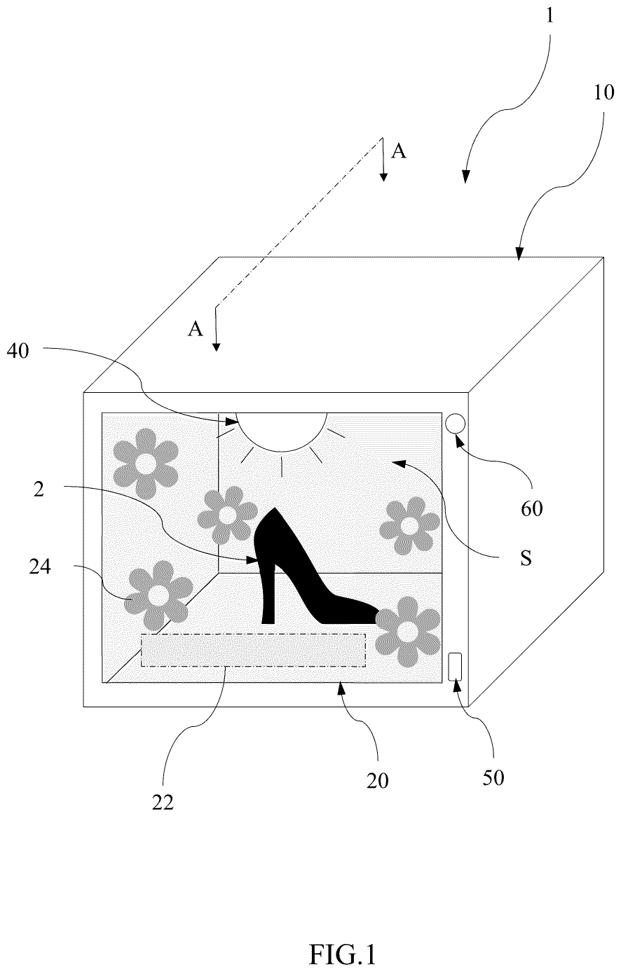

A display case 1 according to an embodiment of the present invention is illustrated in FIG. 1 to FIG. 4 and is adapted to display a display object 2.

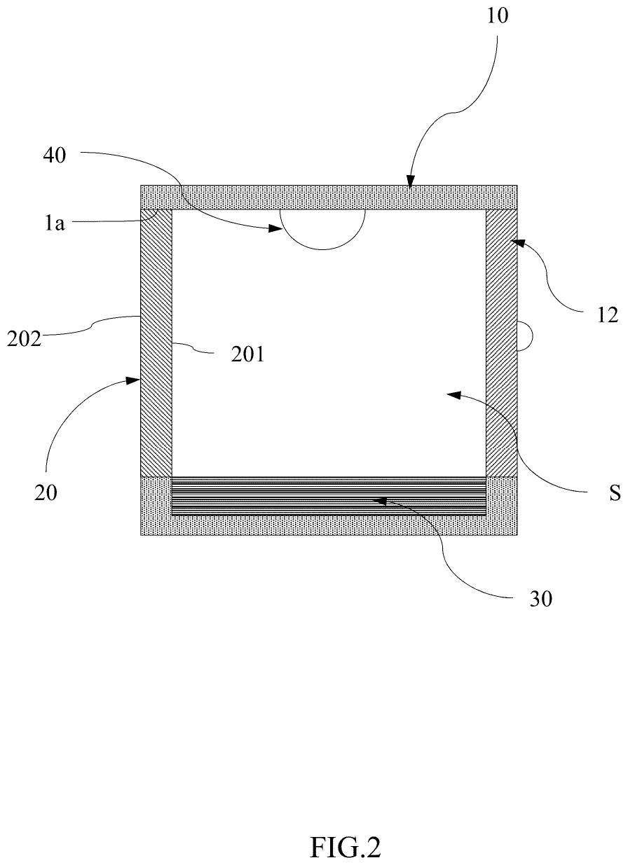

Referring to FIG. 1 and FIG. 2, the display case 1 includes a body 10, a display panel 20, an AI server 30, and a light source 40, wherein the body 10 has a receiving space S and a side opening 1a. The side opening 1a communicates with the receiving space S. The receiving space S is adapted to accommodate the display object 2. The display panel 20 is disposed on the body 10 and covers the side opening 1a. The display panel 20 could be an LCD screen, a LED screen, an OLED screen, or a touchscreen without a backlight module. The display panel 20 has a first side 201 and a second side 202 opposite to each other, wherein the first side 201 faces toward the receiving space S. The second side 202 faces away from the receiving space S, i.e., faces toward an outside of the body 10. A transmittance of the display panel 20 in a direction from the first side 201 to the second side 202 is greater than a transmittance of the display panel 20 in a direction from the second side 202 to the first side 201. The light source 40 is disposed in the body 10 and is controllable to be turned on or turned off. The light source 40 could be a monochromatic LED light strip, a multicolor LED light strip, a monochromatic LED light bulb, or a multicolor LED light bulb. In addition, through a decorative image 24 displayed by the display panel 20 of the display case 1, an effect of decorating the display case 1 could be achieved.

Because the transmittance of the display panel 20 in the direction from the first side 201 to the second side 202 is greater than the transmittance of the display panel 20 in the direction from the second side 202 to the first side 201, a light of the light source 40 could penetrate through the first side 201 to the second side 202 when the light source 40 is turned on. On the contrary, when the light source 40 is turned off, an ambient light outside the display case 1 could not penetrate through the second side 202 to the first side 201.

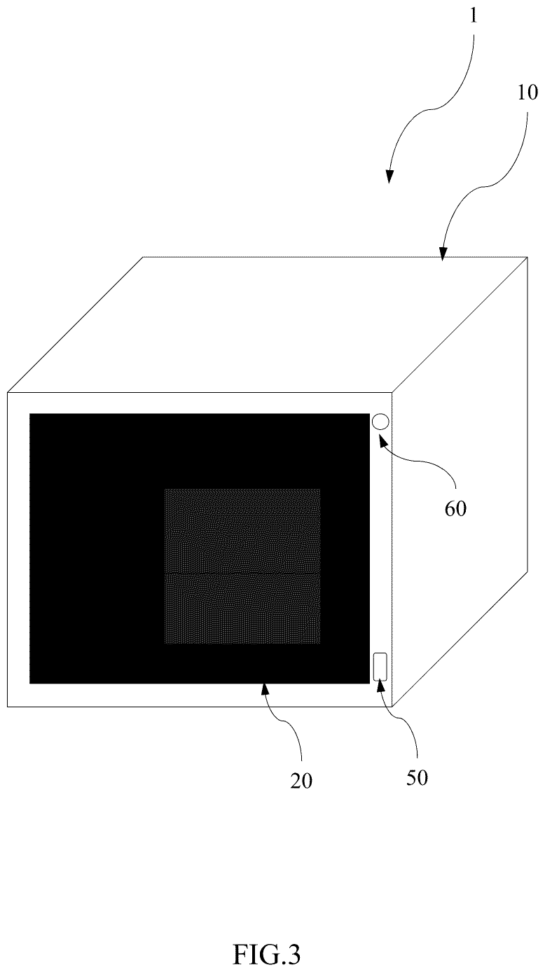

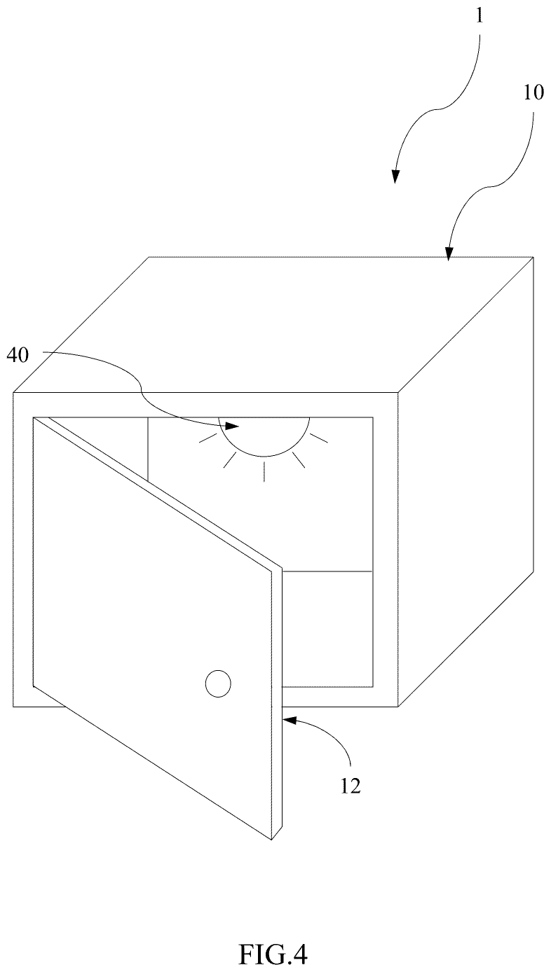

Therefore, when the light source 40 is turned on as shown in FIG. 1, the light of the light source 40 could penetrate through the first side 201 to the second side 202, so that the display object 2 located in the receiving space S could be seen by consumers outside the display case 1 through the display panel 20. When the light source 40 is turned off as shown in FIG. 3, the ambient light outside the display case 1 could not penetrate through the second side 202 to the first side 201, so that the display panel 20 displays a black screen and the display object 2 located in the receiving space S could not be seen by the consumers outside the display case 1. In this way, when the display object 2 needs to be replaced, the display object 2 could be replaced without the display object 2 being seen by the consumers through the light source 40 directly turned off and a case door 12 (as shown in FIG. 4) disposed on a backside of the display case 1 and opened, thereby allowing the display object 2 to be conveniently replaced. In other embodiments, the light source 40 is not limited to being disposed in a top portion of the receiving space S and could be disposed in another location of the body 10.

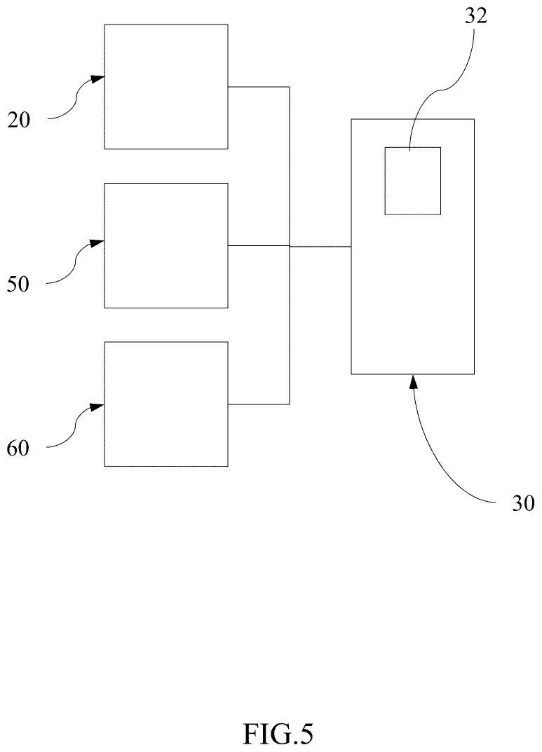

Referring to FIG. 2 and FIG. 5, the AI server 30 is disposed on a bottom portion of the body 10 and is electrically connected to the display panel 20. In other embodiments, the AI server 30 is not limited to being disposed on the bottom portion of the body 10 and could be disposed in another location of the body 10. The AI server 30 includes a processing unit 32, wherein the processing unit 32 is adapted to receive a signal and transform the signal into a text. The processing unit 32 analyzes a meaning of the text and correspondingly generates a reply. The display panel 20 displays the reply. For example, referring to FIG. 1, the display panel 20 has a control interface 22 allowing a user to input data to ask a question. The data could be “Please offer a product information of the display object.” as an example. The display panel 20 outputs the signal to the AI server 30 based on the data. Subsequently, the display panel 20 displays the reply including the product information of the display object 2. The reply could be displayed by the display panel 20 in a form of an image, a video, or a text to interact with the consumers.

More specifically, the processing unit 32 analyzes the meaning of the text. The processing unit 32 evaluates a correlation between the meaning of the text and the display object 2 and correspondingly generates a correlation evaluation result. When the correlation evaluation result is less than a predetermined threshold value, the processing unit 32 generates the reply including a prompt that the meaning of the text is not related to the display object 2, thereby avoiding that the consumers ask the AI server 30 the question irrelevant to the display object 2.

In addition, the processing unit 32 analyzes the meaning of the text. The processing unit 32 evaluates a safety of the meaning of the text and correspondingly generates a safety evaluation result. When the safety evaluation result is greater than a safety threshold value, the processing unit 32 generates the reply including a prompt that the meaning of the text is inappropriate, thereby avoiding that the consumers ask the question including vulgar, rude, or crude words or trade secrets.

Referring to FIG. 1 and FIG. 5, the display case 1 includes a voice device 50, wherein the voice device 50 is disposed on an outer portion of the body 10 and is electrically connected to the AI server 30. The voice device 50 allows the user to input the data and outputs the signal to the AI server 30 based on the data. In other words, in addition to asking through the control interface 22, the consumers could verbally ask through the voice device 50 to input the data. For example, the processing unit 32 includes a speech recognition module and a language model, wherein the speech recognition module is adapted to automatically transform a voice consultation into a transcript consultation. The language model combines the transcript consultation with a knowledge graph to generate the reply. The reply could be displayed by the display panel 20 in the form of the image, the video, or the text or be played by the voice device 50.

Referring to FIG. 1 and FIG. 5, the display case 1 includes a camera 60, wherein the camera 60 is disposed on a front side of the body 10 and is electrically connected to the AI server 30. The camera 60 captures an image and outputs the image to the AI server 30. The image includes a body part of the user. The processing unit 32 analyzes the image and generates a suggestion based on the image. The display panel 20 displays the suggestion. For example, an image of a full body of the consumer could be captured by the camera 60 in front of the display case 1. The processing unit 32 analyzes the image of the full body of the consumer and generates the suggestion based on the image of the full body of the consumer. The suggestion could be a clothing corresponding to a current weather as an example, thereby raising a connection between the consumers and a product.

With the aforementioned design, through the display case 1, the display object 2 could be replaced without the display object 2 being seen by the consumers through the light source 40 being directly turned off, thereby allowing the display object 2 to be conveniently replaced. In addition, through the display panel 20 of the display case 1, the effect of decorating the display case 1 could be achieved, thereby reducing a waste of physical decorations. In addition, through the AI server 30, the consumers could know further about the display object 2, thereby raising the connection between the consumers and the product.

It must be pointed out that the embodiments described above are only some preferred embodiments of the present invention. All equivalent structures which employ the concepts disclosed in this specification and the appended claims should fall within the scope of the present invention.

What is claimed is:

1. A display case adapted to display a display object, comprising:
a body having a receiving space and a side opening, wherein the receiving space is adapted to accommodate the display object;
a display panel disposed on the body and covering the side opening; the display panel has a first side and a second side opposite to each other, wherein the first side faces toward the receiving space; the second side faces away from the receiving space; a transmittance of the display panel in a direction from the first side to the second side is greater than a transmittance of the display panel in a direction from the second side to the first side;
an AI server disposed on the body and electrically connected to the display panel; the AI server comprises a processing unit, wherein the processing unit is adapted to receive a signal and transform the signal into a text; the processing unit analyzes a meaning of the text and correspondingly generates a reply; the display panel displays the reply; and
a light source disposed in the body and being controllable to be turned on or be turned off.

2. The display case as claimed in claim 1, wherein the display panel has a control interface adapted to be inputted data; the display panel outputs the signal to the AI server based on the data.

3. The display case as claimed in claim 1, further comprising a camera, wherein the camera is disposed on the body and is electrically connected to the AI server; the camera captures an image and outputs the image to the AI server; the processing unit analyzes the image and generates a suggestion based on the image; the display panel displays the suggestion.

4. The display case as claimed in claim 3, wherein the image comprises a body part.

5. The display case as claimed in claim 1, further comprising a voice device, wherein the voice device is disposed on the body and is electrically connected to the AI server; the voice device is adapted to be inputted a data and outputs the signal to the AI server based on the data; the voice device plays the reply.

6. The display case as claimed in claim 1, wherein the processing unit analyzes the meaning of the text; the processing unit evaluates a correlation between the meaning of the text and the display object and correspondingly generates a correlation evaluation result; when the correlation evaluation result is less than a predetermined threshold value, the processing unit generates the reply comprising a prompt that the meaning of the text is not related to the display object.

7. The display case as claimed in claim 1, wherein the processing unit analyzes the meaning of the text; the processing unit evaluates a safety of the meaning of the text and correspondingly generates a safety evaluation result; when the safety evaluation result is greater than a safety threshold value, the processing unit generates the reply comprising a prompt that the meaning of the text is inappropriate.

8. The display case as claimed in claim 1, wherein the AI server is disposed on a bottom portion of the body.

9. The display case as claimed in claim 1, wherein the reply comprises a product information of the display object.
